(19) United States
(12) Patent Application Publication
(10) Pub. No.: US 2026/0229495 A1
(43) Pub. Date: Aug. 6, 2026

(54) POSITIVE ELECTRODE AND RECHARGEABLE LITHIUM BATTERY INCLUDING THE SAME

(71) Applicant: SAMSUNG SDI CO., LTD., Yongin-si (KR)

(72) Inventors: Jung Ock YEOU, Yongin-si (KR); HYUN NAM, Yongin-si (KR); JeongJoo PARK, Yongin-si (KR); Jin Seok PARK, Yongin-si (KR); Minho LEE, Yongin-si (KR)

(73) Assignee: SAMSUNG SDI CO., LTD., Yongin-si (KR)

(21) Appl. No.: 19/462,566

(22) Filed: Jan. 28, 2026

(30) Foreign Application Priority Data
Feb. 6, 2025 (KR) 10-2025-0015134

(51) Int. Cl. H01M 4/36; H01M 4/131; H01M 4/525; H01M 4/58; H01M 4/62; H01M 10/052

(52) U.S. Cl. CPC H01M 4/366; H01M 4/131; H01M 4/525; H01M 4/5825; H01M 4/623; H01M 10/052

(57) ABSTRACT

A rechargeable lithium battery positive includes a positive electrode. The positive electrode includes a positive electrode current collector, and a positive electrode active material layer on a surface of the positive electrode current collector. The positive electrode active material layer contains a first positive electrode active material layer on the positive electrode current collector, the first positive electrode active material layer including a first positive electrode active material and a first binder, and a second positive electrode active material on the first positive electrode active material layer, the second positive electrode active material layer including a second positive electrode active material and a second binder. Each of the first positive electrode active material and the second positive electrode active material is or includes a composite oxide having an olivine structure.

### CROSS-REFERENCE TO RELATED APPLICATION

This U.S. nonprovisional application claims priority under 35 U.S.C § 119 to Korean Patent Application No. 10-2025-0015134 filed on Feb. 6, 2025 in the Korean Intellectual Property Office, the disclosure of which is hereby incorporated by reference in its entirety.

### BACKGROUND

The present disclosure relates to a positive electrode for a rechargeable lithium battery, and a rechargeable lithium battery including the positive electrode.

With the proliferation of battery-powered electronic devices such as, e.g., mobile phones, notebook computers, and electric vehicles, the demand for rechargeable batteries with high energy density and large capacity has been increasing. Enhancing the performance of rechargeable lithium batteries may be advantageous.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

### SUMMARY

The present disclosure describes a positive electrode for a rechargeable lithium battery that has desired or improved adhesive strength between the positive electrode current collector and the positive electrode active material layer, and exhibits flexibility. The present disclosure also describes a positive electrode for a rechargeable lithium battery that includes an olivine-structured positive electrode active material and exhibits desired or improved ionic conductivity.

The present disclosure also describes a rechargeable lithium battery having low ionic resistance, high ionic conductivity, and an extended lifetime.

According to an example embodiment of the present disclosure, a positive electrode for a rechargeable lithium battery may include a positive electrode current collector, and a positive electrode active material layer disposed on at least one surface of the positive electrode current collector. The positive electrode active material layer may include a first positive electrode active material layer on the positive electrode current collector, the first positive electrode active material layer including a first positive electrode active material and a first binder; and a second positive electrode active material layer on the first positive electrode active material layer, the second positive electrode active material layer including a second positive electrode active material and a second binder. Each of, or one or more of, the first positive electrode active material and the second positive electrode active material may be or include a composite oxide having an olivine structure. The first binder and the second binder may be different from each other, and the second positive electrode active material layer may have a greater elongation than the first positive electrode active material layer.

According to an example embodiment of the present disclosure, a rechargeable lithium battery may include the positive electrode described above and a negative electrode.

### BRIEF DESCRIPTION OF DRAWINGS

FIG. 1 is a schematic conceptual diagram of a rechargeable lithium battery according to example embodiments of the present disclosure.

FIG. 2, FIG. 3, FIG. 4 and FIG. 5 are schematic cross-sectional views of a rechargeable lithium battery according to an example embodiment.

FIG. 6 is a cross-sectional view of a positive electrode for a rechargeable lithium battery according to example embodiments of the present disclosure.

FIG. 7 is an enlarged view of the region “M” in FIG. 6.

### DETAILED DESCRIPTION OF EMBODIMENTS

To fully understand the configuration and effects of examples of the present disclosure, some example embodiments are described with reference to the accompanying drawings. However, the present disclosure is not limited to the following example embodiments and may be implemented in various forms. The example embodiments are provided solely to illustrate the present disclosure and to enable those skilled in the art to fully understand its scope.

In this description, when an element is described as being “on” another element, the element may be directly on the other element, or one or more intervening elements may be present therebetween. In the drawings, certain thicknesses may be exaggerated to better illustrate technical details. Throughout the specification, like reference numerals indicate like elements.

The example embodiments described herein may be illustrated using sectional and/or plan views, which are presented as idealized examples of the present disclosure. The thicknesses of layers and regions in the drawings may be exaggerated for clarity. The regions shown in the drawings are for illustrative purposes and should not be construed as limiting the scope of the present disclosure. Although terms such as “first,” “second,” and “third” may be used to describe various elements, these terms are merely for distinction and do not imply any particular order or hierarchy. The example embodiments described and illustrated herein include complementary variations.

The terms used in this description serve only to explain various embodiments and are not intended to limit the present disclosure. Unless explicitly stated otherwise, singular forms may also include plural forms. The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) can be measured using widely known methods, such as a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D50). Additionally, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution.

The phrases “A or B,” “at least one of A and B,” “at least one of A or B,” “A, B, or C,” “at least one of A, B, and C,” and “at least one of A, B, or C” include any one or all possible combinations of the listed elements.

When the terms “about” or “substantially” are used in this specification in connection with a numerical value, it is intended that the associated numerical value include a tolerance of ±10% around the stated numerical value. The expression “up to” includes amounts of zero to the expressed upper limit and all values therebetween. When ranges are specified, the range includes all values therebetween such as increments of 0.1%.

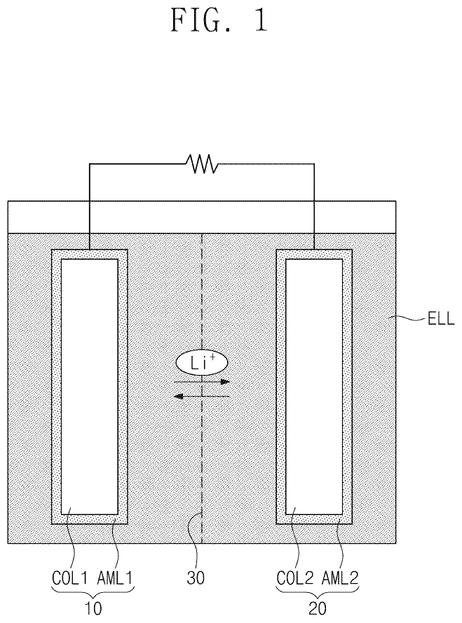

FIG. 1 is a schematic conceptual diagram of a rechargeable lithium battery according to example embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be disposed between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be impregnated in the electrolyte solution ELL.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector. The positive electrode active material layer AML1 may include a positive electrode active material, and may further include a binder and/or a conductive material (e.g., an electrically conductive material).

For example, the positive electrode 10 may further include an additive that can be configured as a sacrificial positive electrode.

An amount of the positive electrode active material may be in a range of about 90 wt % to about 99.5 wt % based on 100 wt % of the positive electrode active material layer AML1. Amounts of the binder and the conductive material may be in a range of about 0.5 wt % to about 5 wt %, respectively, based on 100 wt % of the positive electrode active material layer AML1.

The binder is configured to attach the positive electrode active material particles to each other, and to attach the positive electrode active material to the current collector COL1. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be included to impart conductivity (e.g., electrical conductivity) to the electrode. Any material that does not cause chemical change (e.g., does not cause an undesirable chemical change in the rechargeable lithium battery) and that conducts electrons can be included in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material including at least one of copper, nickel, aluminum, silver, and the like, in a form of a metal powder or a metal fiber; a conductive polymer such as a polyphenylene derivative; or a mixture thereof.

Al may be included as the current collector COL1, but the current collector is not limited thereto.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and a combination thereof may be included.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be included. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤c≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of achieving high capacity, and can be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may be configured to attach the negative electrode active material particles to each other, and to attach the negative electrode active material to the current collector COL2. The binder may include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be included to impart conductivity (e.g., electrical conductivity) to the electrode. Any material that does not cause chemical change (e.g., does not cause an undesirable chemical change in the rechargeable lithium battery) and that conducts electrons can be included in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material AML2 may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be included in combination with a carbon-based negative electrode active material.

### Separator 30

Depending on the type of the rechargeable lithium battery, the separator 30 may be present between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one surface, or on both surfaces, of the porous substrate.

The porous substrate may be or include a polymer film formed of or including any one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Electrolyte ELL

The electrolyte solution ELL for a rechargeable lithium battery may include a non-aqueous organic solvent and a lithium salt.

The non-aqueous organic solvent may be configured as a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethanesulfonate, lithium difluoro (oxalato)borate (LiDFOB), lithium difluorobis(oxalato)phosphate (LiDFBOP), and lithium bis(oxalato)borate (LiBOB).

### Rechargeable Lithium Battery

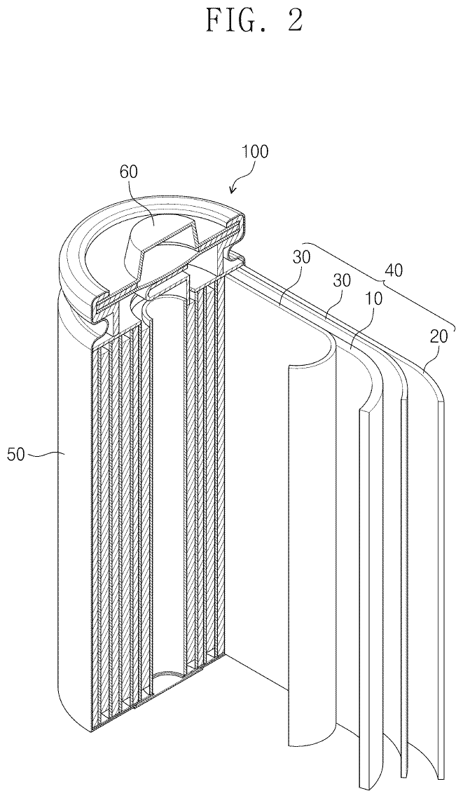

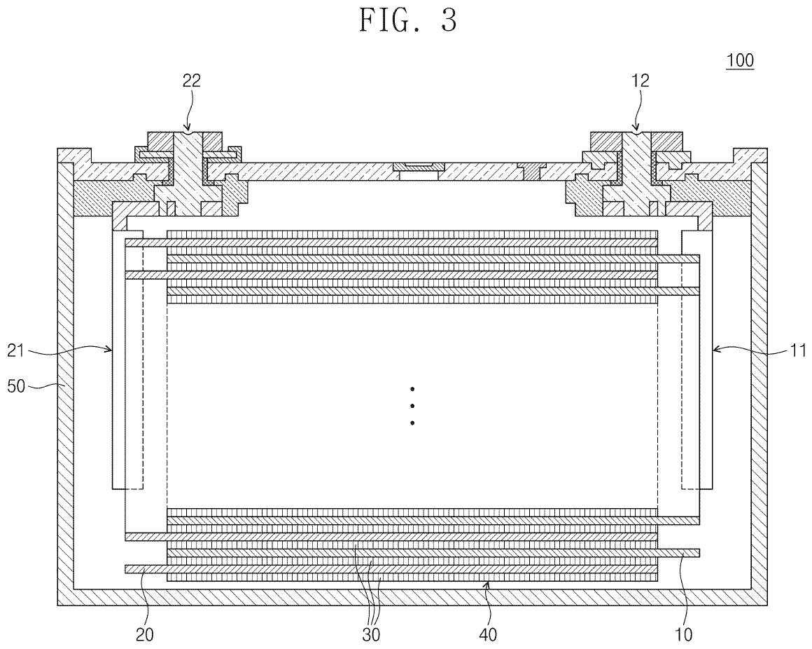

The rechargeable lithium battery may be classified into cylindrical, prismatic, pouch, or coin-type batteries, and the like depending on their shape. FIGS. 2 to 5 are schematic views illustrating a rechargeable lithium battery according to an example embodiment. FIG. 2 shows a cylindrical battery, FIG. 3 shows a prismatic battery, and FIGS. 4 and 5 show pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12 connected to the positive lead tab 11, a negative lead tab 21, and a negative terminal 22 connected to the negative lead tab 21. As shown in FIGS. 4 and 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electrical path for inducing the current formed in the electrode assembly 40 to the outside of the rechargeable lithium battery 100.

The rechargeable lithium battery according to an example embodiment may be applicable to, e.g., automobiles, mobile phones, and/or various types of electric devices, as non-limiting examples.

Hereinafter, a positive electrode 10 according to example embodiments of the present disclosure is described in detail. Hereinafter, for convenience of description, description of the same matters as those described with reference to FIGS. 1 to 5 is omitted, and differences are described in detail.

### Positive Electrode 10

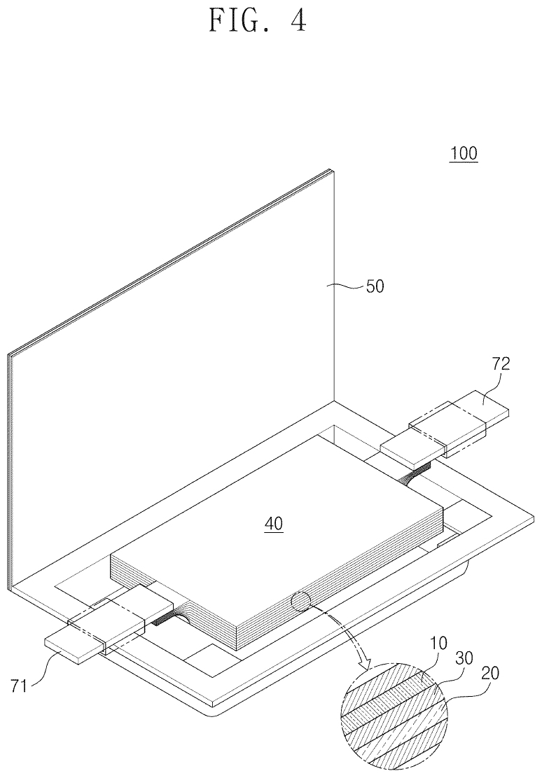

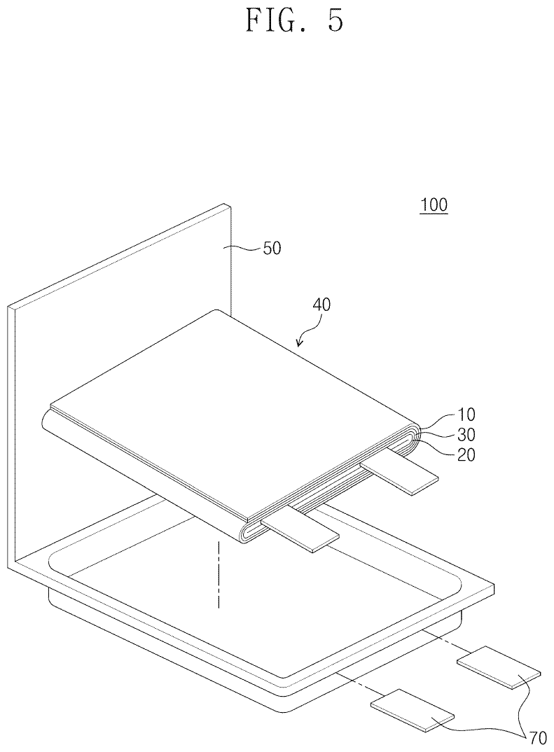

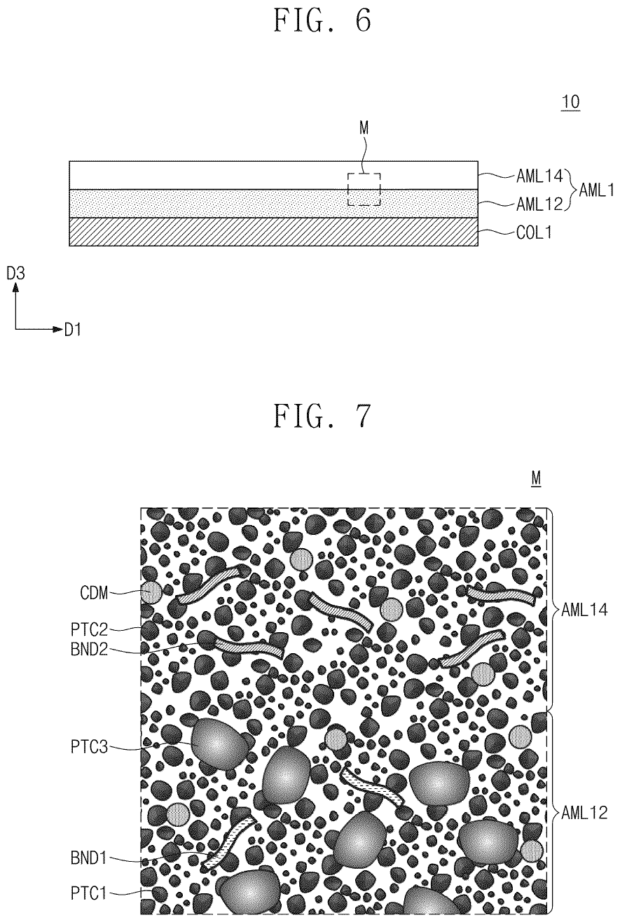

FIG. 6 is a schematic cross-sectional view of a positive electrode 10 according to example embodiments of the present disclosure. FIG. 7 is an enlarged view of the region “M” in FIG. 6.

Referring to FIGS. 6 and 7, the positive electrode 10 for a rechargeable lithium battery may include a positive electrode current collector COL1, and a positive electrode active material layer AML1 formed on the positive electrode current collector COL1. The positive electrode active material layer AML1 may include the first positive electrode active material layer AML12 and the second positive electrode active material layer AML14.

Al may be included as the positive electrode current collector COL1, but the positive electrode current collector COL1 is not limited thereto.

The first positive electrode active material layer AML12 may include a first positive electrode active material PTC1, and may further include a first binder BND1 and/or a conductive material CDM. The second positive electrode active material layer AML14 may include a second positive electrode active material PTC2, and may further include a second binder BND2 and/or a conductive material CDM. The first positive electrode active material layer AML12 may further include a third positive electrode active material PTC3 as a positive electrode active material.

The thickness ratio of the first positive electrode active material layer AML12 to the second positive electrode active material layer AML14 may be in a range of about 1:10 to about 10:1.

When the positive electrode active material layer AML1 includes both the first positive electrode active material layer AML12 and the second positive electrode active material layer AML14, a thick film may be manufactured. When the positive electrode active material layer AML1 includes both the first positive electrode active material layer AML12 and the second positive electrode active material layer AML14, not only desired or improved adhesive strength to the positive electrode current collector COL1 but also the generation of cracks during manufacturing of the electrode plate may be reduced. In addition, a positive electrode and a rechargeable lithium battery including the positive electrode may have low ionic resistance, high ionic conductivity, and an extended lifetime.

A total amount of the positive electrode active material (the first positive electrode active material PTC1 and the third positive electrode active material PTC3) in the first positive electrode active material layer AML12 may be in a range of about 90 wt % to about 99.5 wt % with respect to 100 wt % of the first positive electrode active material layer AML12. An amount of the conductive material CDM may be in a range of about 0.5 wt % to about 5 wt % with respect to 100 wt % of the first positive electrode active material layer AML12.

The conductive material CDM is included to impart conductivity (e.g., electrical conductivity) to the electrode. Any material that does not cause chemical change (e.g., does not cause an undesirable chemical change in the rechargeable lithium battery) and that conducts electrons can be included in the battery. Examples of the conductive material may include at least one of a carbon-based material such as natural graphite, artificial graphite, carbon black, acetylene black, ketjen black, a carbon fiber, a carbon nanofiber, and carbon nanotube; a metal-based material including at least one of copper, nickel, aluminum, silver, and the like, in a form of a metal powder or a metal fiber; a conductive polymer such as a polyphenylene derivative; or a mixture thereof.

The first binder BND1 may be configured to attach the positive electrode active material particles PTC1 and PTC3 to each other, and to attach the positive electrode active materials PTC1 and PTC3 to the positive electrode current collector COL1.

Examples of the first binder BND1 may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride (PVDF), polyethylene, polypropylene, styrene-butadiene rubber, a (meth)acrylated styrene-butadiene rubber, an epoxy resin, a (meth)acrylic resin, a polyester resin, nylon, and the like.

For example, the first binder BND1 may be or include polyvinylidene fluoride (PVDF). For example, the first positive electrode active material layer AML12 may include at least one of polyvinylidene fluoride (PVDF), hydrogenated nitrile butadiene rubber (H-NBR), or a combination thereof as a binder, which may not only improve adhesive strength between the positive electrode current collector COL1 and the first positive electrode active material layer AML12, but also reduce or suppress an increase in resistance during high-temperature storage.

An amount of the first binder BND1 may be in a range of about 0.5 wt % to about 5 wt % with respect to 100 wt % of the first positive electrode active material layer AML12. When the amount of the first binder BND1 satisfies the above-described range, the positive electrode active material particles PTC1 and PTC3 may attach to each other, and the first positive electrode active material layer AML12 may attach to the positive electrode current collector COL1.

As described below, the first positive electrode active material layer AML12 may include the first positive electrode active material PTC1 and the third positive electrode active material PTC3, so that the first positive electrode active material layer AML12 may be adhered to the positive electrode current collector COL1 even with a small amount of the first binder BND1. For example, the amount of the first binder BND1 in the first positive electrode active material layer AML12 may be less than the amount of the second binder BND2 in the second positive electrode active material layer AML14. For example, the amount of the first binder BND1 may be in a range of about 0.5 wt % to about 2 wt % with respect to 100 wt % of the first positive electrode active material layer AML12.

The first positive electrode active material PTC1 may include a compound (lithiated intercalation compound) that is capable of intercalating and deintercalating lithium. For example, a composite oxide of transition metal and lithium may be included. The composite oxide may be or include a lithium transition metal composite oxide.

The first positive electrode active material PTC1 may be or include a composite oxide having an olivine structure. The first positive electrode active material PTC1 may be or include a composite oxide having an olivine structure of a small size. For example, an average particle diameter of the first positive electrode active material PTC1 measured by a particle size analyzer may be in a range of about 0.5 μm to about 5 μm, or about 0.5 μm to about 2.5 μm.

For example, the first positive electrode active material PTC1 may include at least one of a lithium iron phosphate-based compound, a lithium cobalt phosphate-based compound, a lithium manganese phosphate-based compound, or a combination thereof.

The first positive electrode active material layer AML12 may further include a third positive electrode active material PTC3. The third positive electrode active material PTC3 may include a compound (lithiated intercalation compound) that is capable of intercalating and deintercalating lithium. For example, a composite oxide of transition metal and lithium may be included. The composite oxide may be or include a lithium transition metal composite oxide.

The third positive electrode active material PTC3 may be or include a composite oxide of a layered structure. The third positive electrode active material PTC3 may be or include a composite oxide having a layered structure larger in size than the first positive electrode active material PTC1. For example, an average particle diameter of the third positive electrode active material PTC3 measured by a particle size analyzer may be in a range of about 5 μm to about 30 μm, about 5 μm to about 20 μm, or about 5 μm to about 15 μm. For example, a Brunauer Emmett Teller (BET) specific surface area of the third positive electrode active material PTC3 may be smaller than a BET specific surface area of the first positive electrode active material PTC1.

For example, the third positive electrode active material PTC3 may be or include a lithium nickel-based composite oxide. For example, the third positive electrode active material PTC3 may contain about 40 mol % or greater of nickel based on the total amount of elements excluding lithium and oxygen. For example, the third positive electrode active material PTC3 may contain about 50 mol % or greater, about 60 mol % or greater, about 70 mol % or greater, about 80 mol % or greater, about 90 mol % or greater, or about 95 mol % or greater of nickel, and may contain about 99.9 mol % or lower, or about 99 mol % or lower of nickel, based on the total amount of elements excluding lithium and oxygen.

For example, the third positive electrode active material PTC3 may include at least one of lithium nickel oxide, lithium nickel cobalt-based oxide, cobalt-free lithium nickel-manganese-based oxide, or a combination thereof. The lithium nickel cobalt-based oxide may include at least one of lithium nickel-cobalt-aluminum oxide, lithium nickel-cobalt-manganese oxide, or the like.

The first positive electrode active material layer AML12 may further include the third positive electrode active material PTC3 in addition to the first positive electrode active material PTC1, so that the rechargeable lithium battery of the present disclosure may achieve high capacity and high energy density, as well as desired or improved stability, extended cycle life, and cost-effectiveness. When the first positive electrode active material layer AML12 includes both the first positive electrode active material PTC1 and the third positive electrode active material PTC3, rather than just the first positive electrode active material PTC1, the first positive electrode active material layer AML12 may adhere to the positive electrode current collector COL1 even with a relatively smaller amount of a binder. The electrode plate may be more readily manufactured, and the rechargeable lithium battery including the positive electrode may have a lower ionic resistance and a higher ionic conductivity. In addition, when the first positive electrode active material layer AML12 includes both the first positive electrode active material PTC1 and the third positive electrode active material PTC3, rather than just the first positive electrode active material PTC1, larger or more pores may be included within the first positive electrode active material layer AML12. The electrolyte may be more readily impregnated into the first positive electrode active material layer AML12, such that the rechargeable lithium battery may have desired or improved lifetime characteristics.

In the first positive electrode active material layer AML12, an amount of the first positive electrode active material PTC1 may be larger than an amount of the third positive electrode active material PTC3. The weight ratio of the first positive electrode active material PTC1 to the third positive electrode active material PTC3 in the first positive electrode active material layer AML12 may be in a range of about 60:40 to about 90:10. When the weight ratio of the first positive electrode active material PTC1 to the third positive electrode active material PTC3 satisfies the above-described range, the first positive electrode active material layer AML12 may adhere to the positive electrode current collector COL1 even with a relatively small amount of a binder, the electrode plate may be readily manufactured, and a positive electrode and a rechargeable lithium battery having low ionic resistance and high ionic conductivity may be provided. In addition, the first positive electrode active material layer AML12 may provide a rechargeable lithium battery having desired or improved lifetime characteristics.

An amount of the second positive electrode active material PTC2 in the second positive electrode active material layer AML14 may be in a range of about 90 wt % to about 99.5 wt % with respect to 100 wt % of the second positive active material layer AML14. The amount of the conductive material CDM may be in a range of about 0.5 wt % to about 5 wt % with respect to 100 wt % of the second positive electrode active material layer AML14. The conductive material CDM may be as described above.

The second positive electrode active material PTC2 may include a compound (lithiated intercalation compound) that is capable of intercalating and deintercalating lithium. For example, a composite oxide of transition metal and lithium may be included. The composite oxide may be or include a lithium transition metal composite oxide.

The second positive electrode active material PTC2 may be or include a composite oxide having an olivine structure. The second positive electrode active material PTC2 may be or include a composite oxide having an olivine structure of a small size. For example, the average particle diameter of the second positive electrode active material PTC2 measured by a particle size analyzer may be in a range of about 0.5 μm to about 5 μm, or about 0.5 μm to about 2.5 μm.

For example, the second positive electrode active material PTC2 may include at least one of a lithium iron phosphate-based compound, a lithium cobalt phosphate-based compound, a lithium manganese phosphate-based compound, or a combination thereof. For example, the second positive electrode active material PTC2 may be the same as the first positive electrode active material PTC1.

The second binder BND2 may be configured to attach the positive electrode active material particles PTC2 to each other, and to attach the second positive electrode active material PTC2 to the first positive electrode active material layer AML12. In addition, the second binder BND2 may impart flexibility to the positive electrode active material layer AML1, and may improve the ionic conductivity.

The second binder BND2 may have more flexible and elastic properties than the first binder BND1. The elastic modulus (i.e., Young's modulus) of the second binder BND2 may be less than the elastic modulus of the first binder BND1. For example, the elastic modulus of the first binder BND1 may be in a range of about 2.5 GPa to about 3.5 GPa, and the elastic modulus of the second binder BND2 may be in a range of about 0.1 GPa to about 2.5 GPa.

For example, the elastic modulus may be measured using a tensile testing machine (Universal Testing Machine, UTM). For example, the elastic modulus may be measured according to the method defined in ASTM D638. For example, the elastic modulus may be measured at a test speed in a range of about 0.1 mm/min to about 10 mm/min. For example, the elastic modulus may be measured at a temperature in a range of about 20° C. to about 25° C.

The second binder BND2 may have a greater ionic conductivity than the first binder BND1. For example, the ionic conductivity of the first binder BND1 may be about 1×10⁻¹⁴ S/cm or less, and the ionic conductivity of second binder BND2 may be in a range of about 1×10⁻⁶ S/cm to about 1×10⁻³ S/cm.

For example, the ionic conductivity may be measured through impedance spectroscopy. For example, the ionic conductivity may be measured at a temperature in a range of about 20° C. to about 25° C.

The second binder BND2 may comprise at least one of poly(vinylidene fluoride-co-hexafluoropropylene) (P(VDF-co-HFP)), polyacrylonitrile, polyethylene oxide, polyethylene glycol, or a combination thereof.

For example, the second binder BND2 may be different from the first binder BND1.

For example, the first binder BND1 may be or include polyvinylidene fluoride (PVDF) and the second binder BND2 may be or include poly(vinylidene fluoride-co-hexafluoropropylene) (P(VDF-co-HFP)). For example, the second binder BND2 may be or include poly(vinylidene fluoride-co-hexafluoropropylene) (P(VDF-co-HFP)) including from about 5 wt % to about 50 wt % of hexafluoropropylene (HFP). When the amount of the hexafluoropropylene (HFP) in the second binder BND2 satisfies the range described above, the second binder BND2 may have a smaller elastic modulus and a higher ionic conductivity than the first binder BND1.

An amount of the second binder BND2 may be in a range of about 0.5 wt % to 5 wt % with respect to 100 wt % of the second positive electrode active material layer AML14. For example, the amount of the second binder BND2 may be in a range of about 2 wt % to about 5 wt % with respect to 100 wt % of the second positive electrode active material layer AML14.

For example, the ratio of the amount of the second binder BND2 in the second positive electrode active material layer AML14 to the content of the first binder BND1 in the first positive electrode active material layers AML12 (content of second binder/content of first binder) may be in a range of 1 to 5.

When the ratio of the amount of the second binder BND2 in the second positive electrode active material layer AML14 to the amount of the first binder BND1 in the first positive electrode active material layer AML12 satisfies the above-described range, the positive electrode active material particles PTC2 may attach to each other, and the second positive electrode active material layer AML14 may attach to the first positive electrode active material layer AML12. In addition, the positive electrode active material layer AML1 may have flexibility, which may reduce or prevent the generation of cracks during manufacturing of the electrode plate, and the ionic conductivity of the positive electrode active materials layer AML1 may be improved.

By including the second binder BND2, the second positive electrode active materials layer AML14 may have a relatively large elongation. For example, the elongation of the second positive electrode active material layer AML14 may be greater than the elongation of the first positive electrode active material layer AML12. Thus, the second positive electrode active material layer AML14 may reduce the generation of cracks during manufacturing of the electrode plate, and a rechargeable lithium battery having an extended lifetime may be provided.

For example, the elongation may be measured using a tensile testing machine (Universal Testing Machine, UTM). For example, the elongation may be measured using a No. 5 test piece according to the method defined in KS B 0801. For example, the elongation may be measured at a test speed in a range of about 0.1 mm/min to about 30 mm/min, or about 10 mm/min to about 30 mm/min. For example, the elongation may be measured at a temperature in a range of about 20° C. to about 25° C. The elongation may be calculated by fixing both ends of the test piece to clamps of the tensile testing machine, applying a force at a constant speed, measuring the extended length until breakage of the test piece occurs, and comparing the maximum extended length to the initial length. The elongation may be expressed by the following formula.

$$Elongation ( \% ) = ( {L}_{r} - {L}_{0} ) \times 100 / {L}_{0} \qquad Formula$$

In the above formula, L_{f} may be the maximum extended length and L₀ may be the initial length (length of the test piece at the start of the test).

For example, when measured with a No. 5 test piece according to the method defined in KS B 0801 at a temperature of 25° C. using a tensile test machine (Universal Testing Machine, UTM), the elongation of the first positive electrode active material layer AML12 including the first binder BND1 may be in a range of about 0.5% to about 5%, and the elongation of the second positive electrode active material layer AML14 including the second binder BND2 may be in a range of about 5% to about 15%.

When the elongation of the first positive electrode active material layer AML12 and the elongation of the second positive electrode active material layer AML14 satisfy the ranges described above, not only a desired or improved adhesive strength to the positive electrode current collector COL1 may be obtained, but also the generation of cracks during manufacturing of the electrode plate may be reduced. In addition, a positive electrode and a rechargeable lithium battery having low ionic resistance, high ionic conductivity, and an extended lifetime may be provided.

The positive electrode for a rechargeable lithium battery according to the present disclosure, by including the first positive electrode active material layer AML12 and the second positive electrode active material layer AML14, may have adhesive strength between the positive electrode current collector COL1 and the positive electrode active material layer AML1, while allowing the positive electrode active material layer AML1 to have flexibility. As a result, the positive electrode for a rechargeable lithium battery may reduce the presence of cracks occurring during manufacturing. In addition, the positive electrode for a rechargeable lithium battery, while including olivine-structured positive electrode active materials PTC1 and PTC3, may have low ionic resistance and high ionic conductivity. Furthermore, a rechargeable lithium battery having low ionic resistance, high ionic conductivity, and an extended lifetime may be provided.

Hereinafter, the present disclosure is described in more detail with reference to examples. However, the following examples are merely presented to exemplify the present disclosure, and the scope of the present disclosure is not limited thereto.

### EXAMPLE

LiFePO₄ (average particle diameter: 0.61 μm) as the first positive electrode active material, and NCA (LiNi_{0.91}Co_{0.075}Al_{0.015}O₂) (average particle diameter: 9.5 μm) as a third positive electrode active material were prepared. Polyvinylidene fluoride (PVDF) was prepared as the first binder. A carbon nanotube (CNT) was prepared as the conductive material. A first positive electrode active material slurry was prepared by dispersing 97.3 wt % of positive electrode active materials (the weight ratio of the first positive electrode active material to the third positive electrode active material is 77.84:19.46), 1.1 wt % of the first binder, and 1.6 wt % of the conductive material in N-methyl pyrrolidone. Then, the first positive electrode active material slurry was coated on a 15 μm-thick Al foil, dried at 100° C., and then pressed to form a first positive electrode active material layer. The loading level of the first positive electrode active material slurry was 10 g/cm².

LiFePO₄ (average particle diameter: 0.61 μm) was prepared as the second positive electrode active material. Poly(vinylidene fluoride-co-hexafluoropropylene) having the amount of hexafluoropropylene of 30 wt % (P(VDF-co-HFP), 30 wt % HFP) was prepared as the second binder. A second positive electrode active material slurry was prepared by dispersing 94.9 wt % of the second positive electrode active material, 3.3 wt % of the second binder, and 1.8 wt % of the conductive material in N-methyl pyrrolidone. Then, the second positive electrode active material slurry was coated on the first positive electrode active material layer, dried at 100° C., and then pressed to form a second positive electrode active material layer. The loading level of the second positive electrode active material slurry was 10 g/cm². Thus, a positive electrode for a rechargeable lithium battery was manufactured.

In the manufactured positive electrode for a rechargeable lithium battery, the ratio of the amount of the second binder in the second positive electrode active material layer to the amount of the first binder in the first positive electrode active material layer was 3. The total loading level was 20 g/cm², and the mixture density of the positive electrode active material layer was 2.25 g/cc. The total thickness of the first positive electrode active material layer and the second positive electrode active material layer was 60 μm, and the thickness ratio of the first positive active material layer to the second positive electrode active material layer was 1:1.

The elongation of the first positive electrode active material layer including the first binder was 2% and the elongation of second positive electrode active material layer including the second binder was 10%, when measured at 25° C. with a No. 5 test piece according to the method defined in KS B 0801 using a tensile test machine (Universal Testing Machine, UTM). KS B 0801 No. 5 test piece was obtained using a die cutting machine, and the weight and thickness of the obtained piece were determined. The thickness and width of the obtained piece were entered into the tensile test machine, and the elongation of each of the first positive electrode active material layer and the second positive electrode active material layer was measured under the following conditions:
Pre-loading speed: 10 mm/min;
Pre-load: 0.2 kgf; and
Test speed: 30 mm/min.

### Comparative Example 1

A positive electrode was prepared in the same manner as Example 1, with a difference that polyvinylidene fluoride (PVDF) was added as the second binder instead of poly(vinylidene fluoride-co-hexafluoropropylene).

### Comparative Example 2

A positive electrode was prepared in the same manner as Example 1, with a difference that poly(vinylidene fluoride-co-hexafluoropropylene) having the amount of hexafluoropropylene of 30 wt % (P(VDF-co-HFP), 30 wt % HFP) was added as the first binder instead of polyvinylidene fluoride (PVDF).

### Preparation of Rechargeable Lithium Battery

A rechargeable lithium battery was prepared using the above positive electrode, a lithium metal as a counter electrode, a PTFE separator, and a solution in which 1.3 M LiPF₆ was dissolved in ethylene carbonate (EC)+ethyl methyl carbonate (EMC)+dimethyl carbonate (DMC) (at a volume ratio of 3:4:3) used as an electrolyte.

### Evaluation Example: Performance Evaluation of Positive Electrode and Rechargeable Lithium Battery

Adhesion strength evaluation and crack test were performed on the positive electrodes according to Example and Comparative Examples 1 and 2. In addition, the ionic resistance and the lifetime were evaluated for the rechargeable lithium batteries including Example and Comparative Examples 1 and 2.

The adhesive force was evaluated by cutting the positive electrode according to each of Example and Comparative Examples 1 and 2 into a piece of 25 mm×150 mm, fixing it at a center of a 30 mm×200 mm slide glass using a tape, and then measuring a 90-degree peel strength while peeling the positive electrode current collector from the positive electrode active material layer using a UTM.

The crack test was evaluated by observing the positive electrode active material layer with a scanning electron microscope (SEM) immediately after the manufacturing of the positive electrodes according to Example and Comparative Examples 1 and 2. A case where a crack was observed in the positive electrode active material layer was denoted by O, and a case where no crack was observed was denoted by X.

Ionic resistance (Rᵢₒₙ) was measured by the 2-probe method using an impedance analyzer (Solartron 1400A/1455A impedance analyzer) for the rechargeable lithium batteries including Example and Comparative Examples 1 and 2. The frequency range was from 0.1 Hz to 1 M Hz, and the amplitude voltage was 10 mV. The measurements were conducted at 25° C. Ionic resistance was determined from the Nyquist plot of the impedance measurement results. Ionic resistance is inversely related to ionic conductivity.

The lifetime evaluation (capacity retention) was carried out at 25° C. In the first cycle, the rechargeable lithium battery was charged at a constant current of 0.1 C until the battery voltage reached 4.45 V (vs. Li), and once 4.45 V was reached, constant-voltage charging was performed at 4.45 V under a 0.05 C cut-off condition. Then, the rechargeable lithium battery was discharged at a constant current of 0.1 C until the battery voltage reached 2.8 V (vs. Li). After the second cycle, the rechargeable lithium battery was charged at a constant current of 0.5 C until the battery voltage reached 4.45 V (vs. Li), and then discharged at a constant current of 0.5 C until it reached 2.8 V (vs, Li). This cycle was repeated up to 300 cycles. The lifetime evaluation was calculated according to the following formula.

$$Lifetime evaluation ( capacity retention ) ( \% ) = ( Discharge capacity at the 300 th cycle / discharge capacity at the 1 st cycle ) \times 100 \qquad Formula$$

The results are shown in Table 1 below.

TABLE 1

| | Adhesion | Ionic | Lifetime | Crack Test |
|---|---|---|---|---|
| | strength | Resistance | Evaluation | (Existence or |
| Items | (gf/mm) | (Ω/cm²) | (%) | Absence of Crack) |
| Example | 0.71 | 4.5 | 93.5 | X |
| Comparative | 0.73 | 6.5 | 89.0 | ◯ |
| Example 1 | | | | |
| Comparative | 0.12 | 4.3 | 65.2 | X |
| Example 2 | | | | |

Referring to Table 1, the positive electrode according to Example and the rechargeable lithium battery including the positive electrode, included the first positive electrode active material layer including the first binder, and the second positive electrode active material layer including the second binder with a lower elastic modulus and higher ionic conductivity than the first binder, so that cracks were not observed in the positive electrode active material layer, desired or improved adhesive strength of 0.6 gf/mm or more was exhibited, along with a low ionic resistance of 5 Ω/cm² or less and an extended lifetime of 90% or more.

On the other hand, in Comparative Example 1, since the positive electrode only included the first binder with a large elastic modulus and a low ion conductivity, the electrode plate was brittle and readily cracked, resulting in high ionic resistance and a short lifetime for the rechargeable lithium battery.

In Comparative Example 2, since the positive electrode only included the second binder, the adhesive strength between the positive electrode current collector and the positive electrode active material layer was low, leading to detachment of the electrode plate, resulting in a short lifetime for the rechargeable lithium battery.

As a result, it can be confirmed that the positive electrode according to Example exhibited flexibility as well as desired or improved adhesive strength, thereby reducing the generation of cracks during manufacturing of the electrode plate. In addition, it can be confirmed that the positive electrode according to Example and the rechargeable lithium battery including the positive electrode had a low ionic resistance (high ionic conductivity) and an extended lifetime.

In the positive electrode for a rechargeable lithium battery according to one example embodiment of the present disclosure, the positive electrode active material layer may have flexibility as well as desired or improved adhesive strength between the positive electrode current collector and the positive electrode active material layer. This may reduce the possibility of generation of cracks during manufacturing of the positive electrode for a rechargeable lithium battery. In addition, the positive electrode for a rechargeable lithium battery may have low ionic resistance and high ionic conductivity while including a positive electrode active material having an olivine structure.

A rechargeable lithium battery according to one example embodiment of the present disclosure may have a low ionic resistance, a high ionic conductivity, and an extended lifetime.

The above Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Examples.

What is claimed is:

1. A positive electrode for a rechargeable lithium battery, the positive electrode comprising:
a positive electrode current collector; and
a positive electrode active material layer on at least one surface of the positive electrode current collector,
wherein the positive electrode active material layer comprises:
a first positive electrode active material layer on the positive electrode current collector, the first positive electrode active material layer including a first positive electrode active material and a first binder; and
a second positive electrode active material layer on the first positive electrode active material layer, the second positive electrode active material layer including a second positive electrode active material and a second binder,
wherein each of the first positive electrode active material and the second positive electrode active material comprises a composite oxide having an olivine structure,
wherein the first binder and the second binder are different from each other, and
wherein the second positive electrode active material layer has a greater elongation than the first positive electrode active material layer.

2. The positive electrode as claimed in claim 1, wherein an elastic modulus of the second binder is smaller than an elastic modulus of the first binder.

3. The positive electrode as claimed in claim 1, wherein the second binder has a higher ion conductivity than the first binder.

4. The positive electrode as claimed in claim 1, wherein:
the first binder comprises polyvinylidene fluoride (PVDF), and
the second binder comprises poly(vinylidene fluoride-co-hexafluoropropylene) (P(VDF-co-HFP)).

5. The positive electrode as claimed in claim 1, wherein an amount of the first binder in the first positive electrode active material layer is smaller than an amount of the second binder in the second positive electrode active material layer.

6. The positive electrode as claimed in claim 1, wherein a ratio of an amount of the second binder in the second positive electrode active material layer to an amount of the first binder in the first positive electrode active material layer is in a range of about 1 to about 5.

7. The positive electrode as claimed in claim 1, wherein:
an amount of the first binder in the first positive electrode active material layer is in a range of about 0.5 wt % to about 2 wt %, and
an amount of the second binder in the second positive electrode active material layer is in a range of about 2 wt % to about 5 wt %.

8. The positive electrode as claimed in claim 1, wherein at least one of the first positive electrode active material and the second positive electrode active material comprises at least one of a lithium iron phosphate-based compound, a lithium cobalt phosphate-based compound, a lithium manganese phosphate-based compound, and a combination thereof.

9. The positive electrode as claimed in claim 1, wherein:
the first positive electrode active material layer further comprises a third positive electrode active material having a layered structure, and
the third positive electrode active material comprises a lithium nickel-based composite oxide.

10. The positive electrode as claimed in claim 9, wherein the third positive electrode active material comprises at least one of lithium nickel oxide, lithium nickel cobalt-based oxide, cobalt-free lithium nickel-manganese-based oxide, and a combination thereof.

11. The positive electrode as claimed in claim 9, wherein an amount of the first positive electrode active material is greater than an amount of the third positive electrode active material in the first positive electrode active material layer.

12. The positive electrode as claimed in claim 1, wherein each of the first positive electrode active material layer and the second positive electrode active material layer further comprises a conductive material.

13. The positive electrode as claimed in claim 12, wherein the conductive material comprises at least one of a carbon-based material, a metal-based material in the form of a metal powder or a metal fiber, a conductive polymer, and a mixture thereof.

14. The positive electrode as claimed in claim 1, wherein a thickness ratio of the first positive electrode active material layer to the second positive electrode active material layer is in a range of about 1:10 to about 10:1.

15. A rechargeable lithium battery comprising the positive electrode as claimed in claim 1, and a negative electrode.

16. The rechargeable lithium battery as claimed in claim 15, wherein an elastic modulus of the second binder is smaller than an elastic modulus of the first binder.

17. The rechargeable lithium battery as claimed in claim 15, wherein the second binder has a higher ion conductivity than the first binder.

18. The rechargeable lithium battery as claimed in claim 15, wherein:
the first binder comprises polyvinylidene fluoride (PVDF), and
wherein the second binder comprises poly(vinylidene fluoride-co-hexafluoropropylene) (P(VDF-co-HFP)).

19. The rechargeable lithium battery as claimed in claim 15, wherein an amount of the first binder in the first positive electrode active material layer is smaller than an amount of the second binder in the second positive electrode active material layer.

20. The rechargeable lithium battery as claimed in claim 15, wherein a ratio of an amount of the second binder in the second positive electrode active material layer to an amount of the first binder in the first positive electrode active material layer is in a range of about 1 to about 5.
